(19) United States
(12) Patent Application Publication
(10) Pub. No.: US 2015/0177171 A1
(43) Pub. Date: Jun. 25, 2015

(54) GAS SENSOR PACKAGE

(71) Applicant: Samsung Electro-Mechanics Co., Ltd., Suwon (KR)

(72) Inventors: Tae Hoon KIM, Suwon (KR); Tae Kon Koo, Suwon (KR)

(73) Assignee: Samsung Electro-Mechanics Co., Ltd., Suwon (KR)

(21) Appl. No.: 14/196,878

(22) Filed: Mar. 4, 2014

(30) Foreign Application Priority Data
Dec. 20, 2013 (KR) 10-2013-0160117

(51) Int. Cl. G01N 27/12

(52) U.S. Cl. CPC G01N 27/122

(57) ABSTRACT

There is provided a gas sensor package including: a lead frame; a readout integrated circuit device mounted on the lead frame; a gas sensor attached to one surface of the readout integrated circuit device; a micro electro mechanical system (MEMS) cap including an internal space receiving the gas sensor and attached to one surface of the readout integrated circuit device; and a mold part covering the lead frame, the readout integrated circuit device, and the MEMS cap, wherein an upper surface of the MEMS cap and an upper surface of the mold part are formed on the same plane.

### CROSS-REFERENCE TO RELATED APPLICATION

This application claims the benefit of Korean Patent Application No. 10-2013-0160117 filed on Dec. 20, 2013, with the Korean Intellectual Property Office, the disclosure of which is incorporated herein by reference.

### BACKGROUND

The present disclosure relates to a gas sensor package.

As environmentally-caused diseases, such as asthma, and the like, have become a public health issue, public concern about exposure to hazardous airborne pollutants, and the like, has increased. Therefore, world governments have made an effort to intensify national health protection policies by improving the classification of air pollutant groups so as to satisfy the objects of national clean air policies.

Particularly, since it may be considered that modern people spend around 90% or more of their time indoors every day, such as while in the office, at home, or otherwise indoors, indoor environmental conditions have a significant influence on human health.

In addition, as indoor spaces have been further enclosed in order to decrease energy use and increase efficiency in various industrial fields, and use of building materials containing chemicals has increased, residential environmental issues such as sick building syndrome, and the like, have become social issues, levels of performance and functionality required in gas sensors have increased.

Recently, a temperature humidity sensor, a kind of environmental sensor, has been used in smartphones, and interest in gas sensors, as new generation environmental sensors, to be provided in smartphones or wearable devices, has increased.

Further, public interest in gas sensors capable of assisting in the maintenance of comfortable and healthy environments by simply monitoring indoor environmental pollution in a house, an issue which has recently become problematic, and improving indoor environments to contribute to a healthy home life for building inhabitants has increased.

In order to satisfy public interest in gas sensors, as described above, using smartphones, wearable devices, and the like, it is necessary to develop a new gas sensor and a package capable of improving the size, the power consumption, the stability, the sensitivity, response speeds, and the like, of gas sensors, as these elements are somewhat disadvantages in existing gas sensors.

### SUMMARY

An aspect of the present disclosure may provide a gas sensor package capable of being miniaturized and thinned, in which a gas sensor has improved response speeds and sensitivity, and having reduced manufacturing costs.

According to an aspect of the present disclosure, a gas sensor package may include: a lead frame; a readout integrated circuit device mounted on the lead frame; a gas sensor attached to one surface of the readout integrated circuit device; a micro electro mechanical system (MEMS) cap including an internal space receiving the gas sensor and attached to one surface of the readout integrated circuit device; and a mold part covering the lead frame, the readout integrated circuit device, and the MEMS cap, wherein an upper surface of the MEMS cap and an upper surface of the mold part are formed on the same plane.

At least one through hole may be formed in the upper surface of the MEMS cap.

The MEMS cap may include a supporting part contacting the mold part and a plate forming the upper surface of the MEMS cap.

The supporting part and the plate may be formed integrally with each other.

The plate may be coupled to an upper surface of the supporting part.

At least one through hole may be formed to penetrate through the plate.

The plate may have a mesh structure.

The MEMS cap may be formed of a silicon or glass material.

The gas sensor may be attached to one surface of the readout integrated circuit device so as to be electrically connected to the readout integrated circuit device, and the readout integrated circuit device may be electrically connected to the lead frame by a bonding wire.

The lead frame may be any one of a printed circuit board, a metal plate, and a ceramic plate.

According to another aspect of the present disclosure, a gas sensor package may include: a lead frame; a readout integrated circuit device mounted on the lead frame; a gas sensor attached to one surface of the readout integrated circuit device; a MEMS cap including an internal space receiving the gas sensor and attached to one surface of the readout integrated circuit device; and a mold part covering the lead frame, the readout integrated circuit device, and the MEMS cap, wherein an upper surface of the mold part has a height lower than that of an upper surface of the MEMS cap.

When a length from a bottom surface of the lead frame to the upper surface of the mold part is defined as ML and a length from the bottom surface of the lead frame to the upper surface of the MEMS cap is defined as CL, the following Inequality may be satisfied: 0<CL−ML<50 μm.

The lead frame may be any one of a printed circuit board, a metal plate, and a ceramic plate.

According to another aspect of the present disclosure, a gas sensor package may include: a lead frame; a readout integrated circuit device mounted on the lead frame; a gas sensor embedded in the readout integrated circuit device; a MEMS cap including an internal space and attached to one surface of the readout integrated circuit device; and a mold part covering the lead frame, the readout integrated circuit device, and the MEMS cap, wherein an upper surface of the MEMS cap and an upper surface of the mold part are formed on the same plane.

An upper surface of the gas sensor may be exposed to the outside of the readout integrated circuit device.

The gas sensor may be positioned in the internal space of the MEMS cap.

The lead frame maybe any one of a printed circuit board, a metal plate, and a ceramic plate.

### BRIEF DESCRIPTION OF DRAWINGS

The above and other aspects, features and other advantages of the present disclosure will be more clearly understood from the following detailed description taken in conjunction with the accompanying drawings, in which:

FIG. 1 is a schematic cross-sectional view of a gas sensor package according to an exemplary embodiment of the present disclosure;

FIG. 2 is a flow chart showing a manufacturing method of the gas sensor package according to the exemplary embodiment of the present disclosure;

FIG. 3 is a schematic cross-sectional view showing a modified example of a micro electro mechanical system (MEMS) cap of the gas sensor package according to the exemplary embodiment of the present disclosure;

FIGS. 4A and 5A are schematic cross-sectional views of gas sensor packages according to other exemplary embodiments of the present disclosure;

FIGS. 4B and 5B are schematic cross-sectional views showing modified examples of micro electro mechanical system (MEMS) caps of the gas sensor packages according to other exemplary embodiments of the present disclosure;

FIG. 6A is a schematic cross-sectional view of a gas sensor provided in the gas sensor package according to the exemplary embodiment of the present disclosure;

FIG. 6B is a schematic cross-sectional view showing a modified example of the gas sensor provided in the gas sensor package according to the exemplary embodiment of the present disclosure;

FIG. 7A is a schematic cross-sectional view of a gas sensor provided in a gas sensor package according to another exemplary embodiment of the present disclosure;

FIG. 7B is a schematic cross-sectional view showing a modified example of the gas sensor provided in the gas sensor package according to another exemplary embodiment of the present disclosure; and

FIG. 8 is a schematic cross-sectional view of a gas sensor package according to another exemplary embodiment of the present disclosure.

### DETAILED DESCRIPTION

Hereinafter, embodiments of the present disclosure will be described in detail with reference to the accompanying drawings. The disclosure may, however, be embodied in many different forms and should not be construed as being limited to the embodiments set forth herein. Rather, these embodiments are provided so that this disclosure will be thorough and complete, and will fully convey the scope of the disclosure to those skilled in the art. In the drawings, the shapes and dimensions of elements maybe exaggerated for clarity, and the same reference numerals will be used throughout to designate the same or like elements.

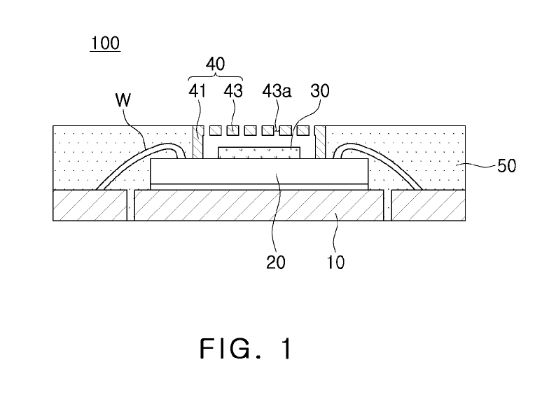

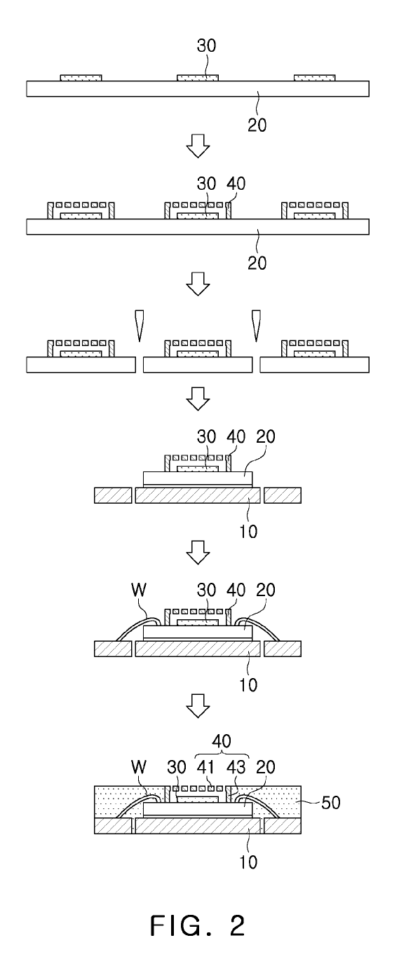

FIG. 1 is a schematic cross-sectional view of a gas sensor package according to an exemplary embodiment of the present disclosure, and FIG. 2 is a flow chart showing a manufacturing method of the gas sensor package according to the exemplary embodiment of the present disclosure.

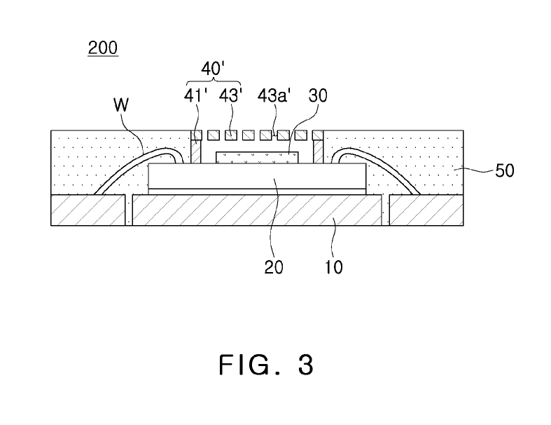

FIG. 3 is a schematic cross-sectional view showing a modified example of a micro electro mechanical system (MEMS) cap of the gas sensor package according to the exemplary embodiment of the present disclosure.

Referring to FIGS. 1 through 3, the gas sensor package 100 according to an exemplary embodiment of the present disclosure may include a lead frame 10, a readout integrated circuit device 20, a gas sensor 30, a MEMS cap 40, and a mold part 50.

The readout integrated circuit device 20 may be mounted on the lead frame 10.

The lead frame 10 may serve as a wire connecting the readout integrated circuit device 20 and an external circuit to each other and serve to fix the gas sensor package according to an exemplary embodiment of the present disclosure to an electronic circuit board.

The lead frame 10 may be formed of a metal material. For example, the lead frame 10 may be formed of nickel, an iron alloy, or a copper alloy. However, the spirit of the present disclosure is not limited by the material of the lead frame 10.

In addition, a configuration on which the readout integrated circuit device 20 is mounted is not limited to the lead frame 10, but the lead frame 10 may be substituted by any one of a printed circuit board (PCB), a metal plate, and a ceramic plate.

The readout integrated circuit device 20 may be electrically connected to the lead frame 10 by a bonding wire W.

The gas sensor 30 may be attached to one surface of the readout integrated circuit device 20 and electrically connected to the readout integrated circuit device 20.

The gas sensor 30 may refer to an apparatus sensing a specific chemical contained in gas and converting a concentration of the specific chemical into an electric signal to output the electric signal, and the readout integrated circuit device 20 may be a circuit device processing the signal transferred from the gas sensor 30.

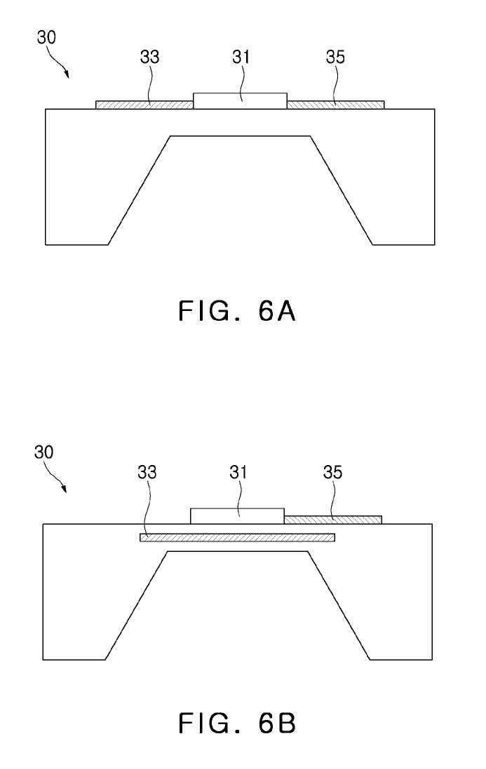

Referring to FIGS. 6A and 6B, the gas sensor 30 may include a sensing member 31, a heater 33, and a sensing electrode 35 on one surface thereof.

The sensing member 31 may be heated by the heater 33 to a temperature suitable for detecting the specific chemical contained in the gas.

Meanwhile, the heater 33 may be arranged in parallel with the sensing member 31 as shown in FIG. 6A but embedded in the gas sensor 30 to thereby be disposed below the sensing member 31 as shown in FIG. 6B.

The MEMS cap 40 may include an internal space capable of receiving the gas sensor 30 and be attached to one surface of the readout integrated circuit device 20.

The MEMS cap 40 may refer to a structure using a semiconductor process known as a micro electro mechanical system (MEMS), particularly, micromachining technology applying integrated circuit technology.

The mold part 50 may cover the lead frame 10, the readout integrated circuit device 20, and the MEMS cap 40.

The mold part 50 may prevent short-circuits between the lead frame 10, the readout integrated circuit device 20 and the MEMS cap 40 and fix the lead frame 10, the readout integrated circuit device 20, and the MEMS cap 40 in a shape in which the mold part encloses the lead frame 10, the readout integrated circuit device 20, and the MEMS cap 40 to thereby safely protect the gas sensor package according to an exemplary embodiment of the present disclosure from external impacts.

The mold part 50 may cover the lead frame 10 and the readout integrated circuit device 20 and be formed in a shape in which the mold part is closely attached to a side surface of the MEMS cap 40, such that the mold part 50 may protect the lead frame 10, the readout integrated circuit device 20, and the MEMS cap 40 from an external environment.

The mold part 50 may be formed by a molding method. In this case, at least one of a silicone gel having high thermal conductivity, an epoxy mold compound (EMC), polyimide may be used as a material of the mold part 50.

However, the present disclosure is not limited thereto, but in order to form the mold part 50, if necessary, various methods such as a method of compressing a semi-cured resin, or the like, may be used.

The MEMS cap 40 may include a supporting part 41 contacting the mold part 50 and a plate 43 forming an upper surface of the MEMS cap 40, and the supporting part 41 and the plate 43 may be formed integrally with each other.

In this case, the MEMS cap 40 including the supporting part 41 and the plate 43 may be formed of a silicon (Si) or glass material.

However, as shown in FIG. 3, a MEMS cap 40′ may have a shape in which a supporting part 41′ and a plate 43′ are formed of different materials, and the plate 43′ is coupled to an upper surface of the supporting part 41′.

In this case, a material of the plate 43′ may be silicon (Si) or glass.

At least one through hole 43a may be formed in the upper surface of the MEMS cap 40.

For example, a plurality of through holes 43a penetrating through the plate 43 forming the upper surface of the MEMS cap 40 may be formed in the plate 43.

Further, the plate 43 may be formed to have a mesh structure, a net structure, or a structure in which the plurality of through holes 43a penetrate through the plate to form a lattice structure.

The gas sensor 30 may sense a specific chemical contained in a gas introduced through the plurality of through holes 43a.

Meanwhile, the upper surface of the MEMS cap 40 and an upper surface of the mold part 50 may be positioned on the same plane. Therefore, the upper surface of the MEMS cap 40 may be exposed to the outside of the mold part 50.

Since the upper surface of the MEMS cap 40 maybe exposed to the outside of the mold part 50, a reaction range of the gas sensor 30 arranged in the internal space of the MEMS cap 40 and the gas may be increased.

Therefore, a response speed and sensitivity of the gas sensor 30 may be improved.

In the gas sensor package according to an exemplary embodiment of the present disclosure, since the readout integrated circuit device 20 and the gas sensor 30 may be implemented in a single package, an overall size of the gas sensor package may be decreased.

Hereinafter, the manufacturing method of the gas sensor package according to an exemplary embodiment of the present disclosure will be described with reference to FIG. 2.

First, the gas sensors 30 maybe attached to one surface of the readout integrated circuit device 20.

Next, the MEMS caps 40 may be attached to one surface of the readout integrated circuit device 20 so as to enclose the gas sensors 30, and each unit package may be separated.

Thereafter, the readout integrated circuit device 20 may be mounted on the lead frame 10, and the lead frame 10 and the readout integrated circuit device 20 may be electrically connected to each other by a bonding wire W.

The mold part 50 may be formed by a molding method so as to cover the lead frame 10 and the readout integrated circuit device 20.

In this case, the mold part 50 may be closely attached to the side surface of the MEMS cap 40, and the upper surface of the MEMS cap 40 and the upper surface of the mold part 50 may be formed on the same plane.

The gas sensor package may be manufactured by a wafer level package method using the manufacturing method as described above, thereby improving productivity.

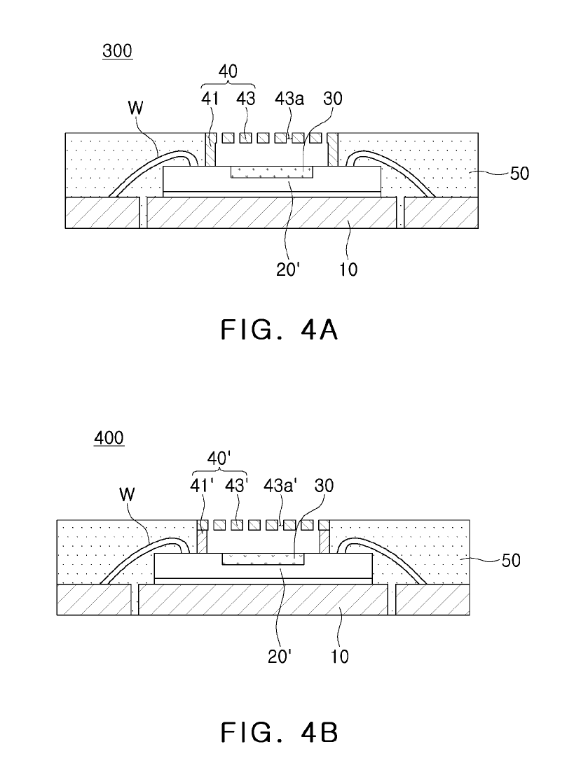

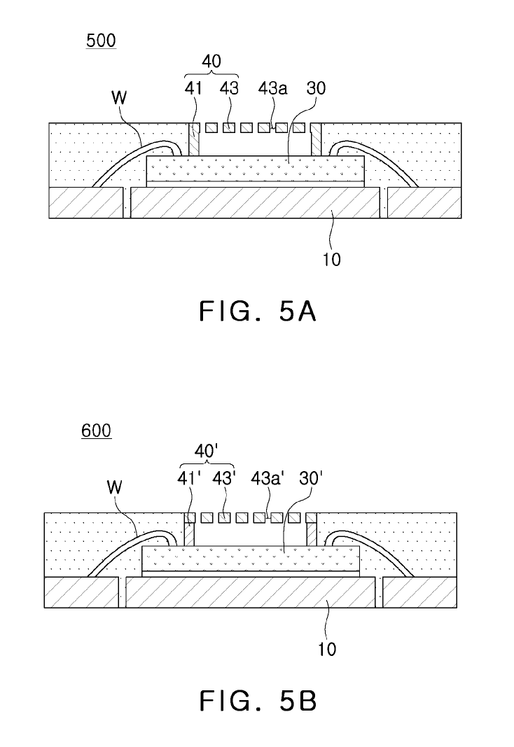

FIGS. 4A and 5A are schematic cross-sectional views of gas sensor packages according to other exemplary embodiments of the present disclosure, and FIGS. 4B and 5B are schematic cross-sectional views showing modified examples of micro electromechanical system (MEMS) caps of the gas sensor packages according to other exemplary embodiments of the present disclosure.

Referring to FIG. 4A, since a gas sensor package 300 according to another exemplary embodiment of the present disclosure is the same as the gas sensor package 100 according to the exemplary embodiment of the present disclosure as described above, except for an arrangement of the gas sensor 30, a description thereof will be omitted, except for the arrangement of the gas sensor 30.

In the gas sensor package 300 according to another exemplary embodiment of the present disclosure, the gas sensor 30 may be embedded in a readout integrated circuit device 20′.

In this case, an upper surface of the gas sensor 30 may be exposed to the outside of the readout integrated circuit device 20′ and positioned in the internal space of the MEMS cap 40.

Since the gas sensor 30 may be embedded in the readout integrated circuit device 20′, a total height of the gas sensor package may be decreased, and the gas sensor package may be miniaturized and thinned.

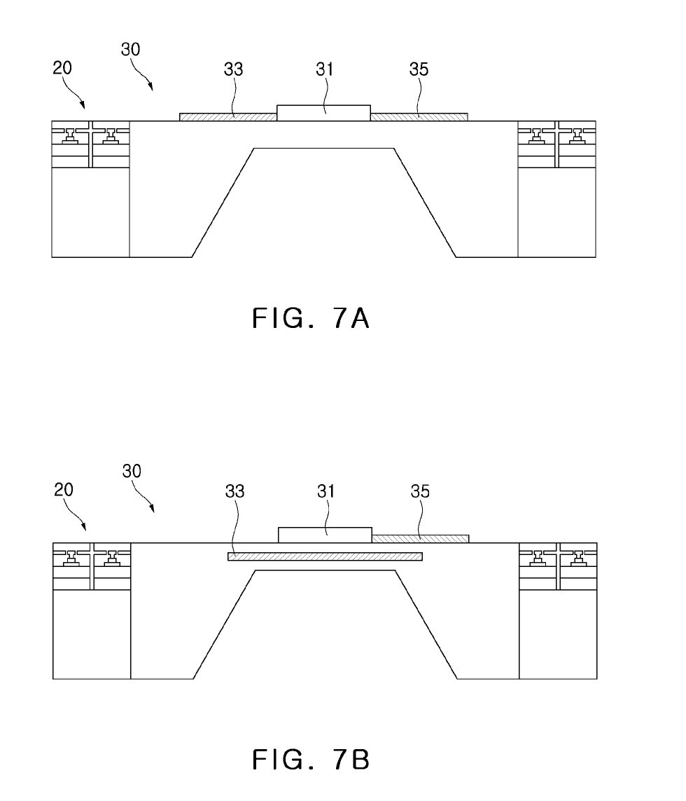

Referring to FIGS. 7A and 7B, the gas sensor 30 may include a sensing member 31, a heater 33, and a sensing electrode 35 on one surface thereof.

The sensing member 31 may be heated by the heater 33 to a temperature suitable for detecting the specific chemical contained in the gas.

Further, the heater 33 may be arranged in parallel with the sensing member 31 as shown in FIG. 7A but embedded in the gas sensor 30 to thereby be disposed below the sensing member 31 as shown in FIG. 7B.

Meanwhile, referring to FIG. 5A, in a gas sensor package 500 according to another exemplary embodiment of the present disclosure, a gas sensor 30 may be mounted on a lead frame 10, and the gas sensor 30 may be electrically connected to the lead frame 10 by a bonding wire W.

In a MEMS cap 40, a supporting part 41 and a plate 43 may be formed integrally with each other, similarly to the gas sensor package according the exemplary embodiment of the present disclosure as described above, or, as shown in FIGS. 4B and 5B, a MEMS cap 40′ may have a shape in which a support part 41′ and a plate 43′ may be formed of different materials, and the plate 43′ is coupled to an upper surface of the supporting part 41′.

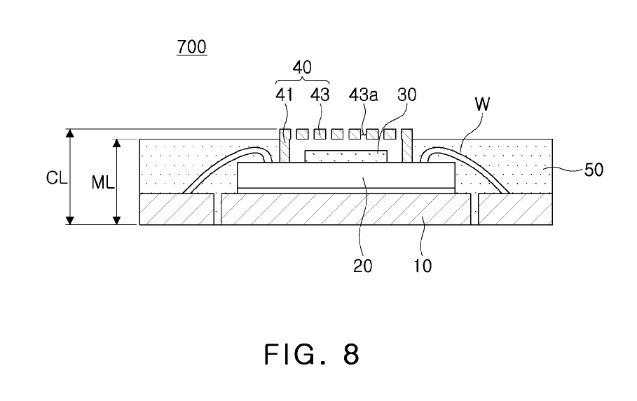

FIG. 8 is a schematic cross-sectional view of a gas sensor package according to another exemplary embodiment of the present disclosure.

Referring to FIG. 8, since a gas sensor package 700 according to another exemplary embodiment of the present disclosure is the same as the gas sensor package 100 according to the exemplary embodiment of the present disclosure as described above except that an upper surface of a mold part 50 has a height lower than that of an upper surface of a MEMS cap 40, a description thereof except for the upper surface of the mold part 50 and the upper surface of the MEMS cap 40 will be omitted.

In the gas sensor package 700 according to another exemplary embodiment of the present disclosure, the upper surface of the mold part 50 may have a height lower than that of the upper surface of the MEMS cap 40.

For example, a length ML from a bottom surface of a lead frame 10 to the upper surface of the mold part 50 may be shorter than a length CL from the bottom surface of the lead frame 10 to the upper surface of the MEMS cap 40.

That is, CL may be larger than ML (CL>ML). More specifically, the gas sensor package 700 according to another exemplary embodiment of the present disclosure may satisfy the following Inequality: 0<CL−ML<50 μm.

In this exemplary embodiment, since the upper surface of the mold part 50 may have a height lower than that of the upper surface of the MEMS cap 40, a side surface of the MEMS cap 40 maybe partially exposed to the outside of the mold part 50.

Therefore, although not shown in FIG. 8, at least one through holes 43a penetrating through the plate 43 of the MEMS cap 40 may be formed at a portion of the side surface of the MEMS cap 40 exposed to the outside of the mold part 50.

Therefore, a reaction range of the gas sensor 30 and gas may be increased, and a response speed and sensitivity of the gas sensor 30 may be further improved.

As set forth above, according to exemplary embodiments of the present disclosure, the gas sensor package may be miniaturized and thinned, improve the response speed and sensitivity of the gas sensor, and decrease manufacturing costs.

While exemplary embodiments have been shown and described above, it will be apparent to those skilled in the art that modifications and variations could be made without departing from the spirit and scope of the present disclosure as defined by the appended claims.

What is claimed is:

1. A gas sensor package comprising:
a lead frame;
a readout integrated circuit device mounted on the lead frame;
a gas sensor attached to one surface of the readout integrated circuit device;
a micro electro mechanical system (MEMS) cap including an internal space receiving the gas sensor and attached to one surface of the readout integrated circuit device; and
a mold part covering the lead frame, the readout integrated circuit device, and the MEMS cap,
wherein an upper surface of the MEMS cap and an upper surface of the mold part are formed on the same plane.

2. The gas sensor package of claim 1, wherein at least one through hole is formed in the upper surface of the MEMS cap.

3. The gas sensor package of claim 1, wherein the MEMS cap includes a supporting part contacting the mold part and a plate forming the upper surface of the MEMS cap.

4. The gas sensor package of claim 3, wherein the supporting part and the plate are formed integrally with each other.

5. The gas sensor package of claim 3, wherein the plate is coupled to an upper surface of the supporting part.

6. The gas sensor package of claim 3, wherein at least one through hole is formed to penetrate through the plate.

7. The gas sensor package of claim 3, wherein the plate has a mesh structure.

8. The gas sensor package of claim 1, wherein the MEMS cap is formed of a silicon or glass material.

9. The gas sensor package of claim 1, wherein the gas sensor is attached to one surface of the readout integrated circuit device so as to be electrically connected to the readout integrated circuit device, and the readout integrated circuit device is electrically connected to the lead frame by a bonding wire.

10. The gas sensor package of claim 1, wherein the lead frame is any one of a printed circuit board, a metal plate, and a ceramic plate.

11. A gas sensor package comprising:
a lead frame;
a readout integrated circuit device mounted on the lead frame;
a gas sensor attached to one surface of the readout integrated circuit device;
a MEMS cap including an internal space receiving the gas sensor and attached to one surface of the readout integrated circuit device; and
a mold part covering the lead frame, the readout integrated circuit device, and the MEMS cap,
wherein an upper surface of the mold part has a height lower than that of an upper surface of the MEMS cap.

12. The gas sensor package of claim 11, wherein when a length from a bottom surface of the lead frame to the upper surface of the mold part is defined as ML and a length from the bottom surface of the lead frame to the upper surface of the MEMS cap is defined as CL, the following Inequality is satisfied: 0<CL−ML<50 μm.

13. The gas sensor package of claim 11, wherein the lead frame is any one of a printed circuit board, a metal plate, and a ceramic plate.

14. A gas sensor package comprising:
a lead frame;
a readout integrated circuit device mounted on the lead frame;
a gas sensor embedded in the readout integrated circuit device;
a MEMS cap including an internal space and attached to one surface of the readout integrated circuit device; and
a mold part covering the lead frame, the readout integrated circuit device, and the MEMS cap,
wherein an upper surface of the MEMS cap and an upper surface of the mold part are formed on the same plane.

15. The gas sensor package of claim 14, wherein an upper surface of the gas sensor is exposed to the outside of the readout integrated circuit device.

16. The gas sensor package of claim 15, wherein the gas sensor is positioned in the internal space of the MEMS cap.

17. The gas sensor package of claim 14, wherein the lead frame is any one of a printed circuit board, a metal plate, and a ceramic plate.
